(19) United States
(12) Patent Application Publication
(10) Pub. No.: US 2010/0081419 A1
(43) Pub. Date: Apr. 1, 2010

(54) COMMUNICATION METHOD AND COMMUNICATION DEVICE THEREOF

(75) Inventors: Ching-Liang Chiang, Taoyuan (TW); Chih-Wei Tai, Taoyuan (TW); Chi-Nien Chen, Taoyuan (TW); Tai-Ling Lu, Taoyuan (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HTC CORPORATION, Taoyuan County (TW)

(21) Appl. No.: 12/536,623

(22) Filed: Aug. 6, 2009

(30) Foreign Application Priority Data
Sep. 26, 2008 (US) 12239529
Dec. 1, 2008 (TW) 97146680
Dec. 9, 2008 (CN) 200810186982.2

(51) Int. Cl. H04M 3/42; H04W 4/00

(52) U.S. Cl. 455/416; 345/173; 455/466

(57) ABSTRACT

A communication method and a communication device thereof are provided. The communication method includes the steps of: displaying a calling window when a telephone connection between a calling party of the communication device and a called party is established; displaying a contact list window showing at least one contact item corresponding to at least one contact; dragging and dropping one of the at least one contact item from the contact list window to the calling window; performing a communication function relating to the called party and the dragged and dropped contact item.

This application claims the benefit of U.S. application Ser. No. 12/239,529, filed Sep. 26, 2008 and Taiwan application Serial No. 97146680, filed Dec. 1, 2008, the subject matter of which is incorporated herein by reference.

### BACKGROUND OF THE INVENTION

1. Field of the Invention

The invention relates in general to a communication method and a communication device thereof, and more particularly to a communication method implemented by a drag-and-drop operation, and a communication device thereof.

2. Description of the Related Art

With the development of the technology, communication devices have become more and more popular. Users can talk with each other and may also exchange information through the communication devices.

In some cases, the user may get a caller's phone call for asking a telephone number of a third party. At this time, the user needs to have the caller wait for a moment, and then the user opens the address book of the communication device and searches whether the address book contains the telephone number of the third party, and then tells the caller the result.

However, after the user spends a long time to find the telephone number of the third party, the user has to remember or write down the telephone number, and then tell the caller. Consequently, the method of forwarding the telephone number of the third party is very inconvenient to the user, and the forwarded message tends to have errors because the user may incorrectly remember the telephone number. In addition, this method also needs to let the caller spend a long time to wait, and the communication cost is thus increased.

In addition, the communication device usually has the function of a multi-party conference call. In the conventional communication device, however, if the calling party wants to proceed the multi-party conference call, the calling party usually has to open the address book and select the telephone number of one contact after the telephone connection is established. Then, after the other telephone connection is established, the three-party conference call has to be set. Sometimes, the calling party tends to unintentionally hang up the phone when the calling party incorrectly touches the screen or when the calling party is unfamiliar with the setting method of the three-party conference call. This inconvenience in use tends to bring some unessential trouble to the calling party.

### SUMMARY OF THE INVENTION

The invention is directed to a communication method and a communication device thereof having the advantages that the operation of the calling party is easy, that the error cannot easily occur, that the communication function between the called party and the associated dragged and dropped contact item can be effectively performed and that the waiting time of each of the calling party and the called party can be shortened so that the product competitiveness is very high.

According to a first aspect of the present invention, a communication method is provided. The method includes the following steps. When a telephone connection between a calling party of a communication device and a called party is established, a calling window is displayed. A contact list window showing at least one contact item corresponding to at least one contact is displayed. One of the at least one contact item is dragged and dropped from the contact list window to the calling window. A communication function relating to the called party and the dragged and dropped contact item is performed.

According to a second aspect of the present invention, a communication device including a screen, a control module and a communication module is provided. The screen displays a calling window and displays a contact list window showing at least one contact item corresponding to at least one contact when a telephone connection between a calling party of the communication device and a called party is established. The control module controls the screen and drags and drops one of the at least one contact item from the contact list window to the calling window in response to a calling party event. The communication module performs a communication function relating to the called party and the dragged and dropped contact item.

The invention will become apparent from the following detailed description of the preferred but non-limiting embodiments. The following description is made with reference to the accompanying drawings.

### BRIEF DESCRIPTION OF THE DRAWINGS

FIG. 1 is a flow chart showing a communication method.

FIG. 2 is a block diagram showing an example of a communication device for performing the communication method of FIG. 1.

FIGS. 3A to 3D are schematic illustrations showing an example of a screen frame in the communication method of FIG. 1.

FIGS. 4A to 4D are schematic illustrations showing another example of the screen frame in the communication method of FIG. 1.

### DETAILED DESCRIPTION OF THE INVENTION

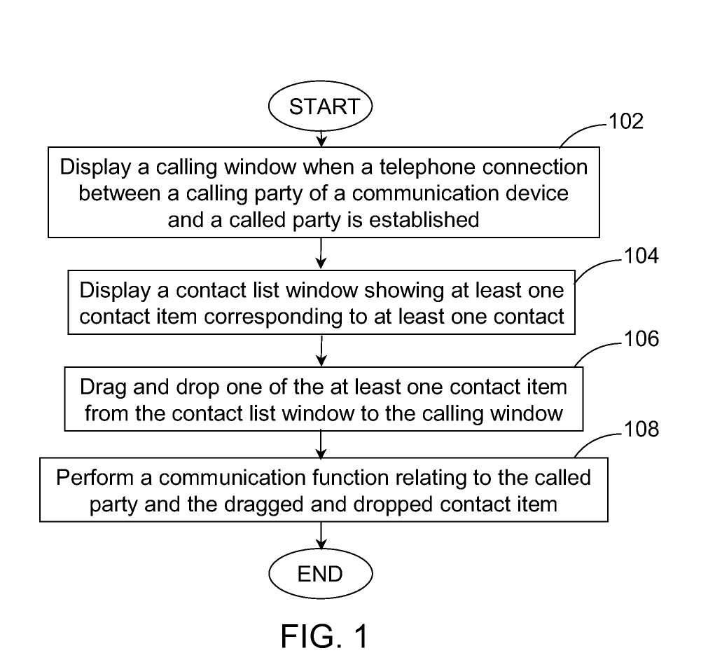

FIG. 1 is a flow chart showing a communication method. Referring to FIG. 1, the method includes steps 102, 104, 106 and 108. In the step 102, when a telephone connection between a calling party of a communication device and a called party is established, a calling window is displayed. In the step 104, a contact list window, which shows at least one contact item corresponding to at least one contact, is displayed. In the step 106, one of the at least one contact item is dragged and dropped from the contact list window to the calling window. In the step 108, a communication function, which relates to the called party and the dragged and dropped contact item, is performed.

The communication function may be the function of transmitting at least a portion of contact information (vCard/Versitcard) of the dragged and dropped contact item to the called party, or may be the function of performing a three-party conference call among the contact of the dragged and dropped contact item, the calling party and the called party.

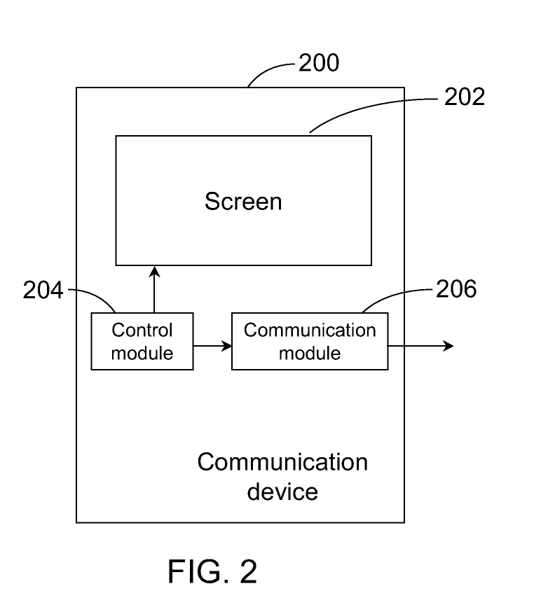

FIG. 2 is a block diagram showing an example of a communication device 200 for performing the communication method of FIG. 1. Referring to FIG. 2, the communication device 200 includes a screen 202, a control module 204 and a communication module 206. The screen 202 displays the calling window when the telephone connection between the calling party of the communication device and the called party is established, and displays the contact list window. The control module 204 controls the screen 202 and drags and drops the at least one contact item from the contact list window to the calling window in response to a calling party event. The communication module 206 performs the communication function. The calling party event is, for example, an event generated when the calling party operates the screen. The details will be described in the following.

When the telephone connection between the calling party and the called party is being established, and the called party asks the calling party a third party's contact information, or the calling party actively wants to transmit the third party's contact information to the called party, the calling party can quickly transmit the third party's contact information to the called party only through a simple drag-and-drop operation. This method can quickly and correctly transmit the third party's contact information so that the calling party can enjoy the high convenience in use and the waiting time of the called party can be shortened.

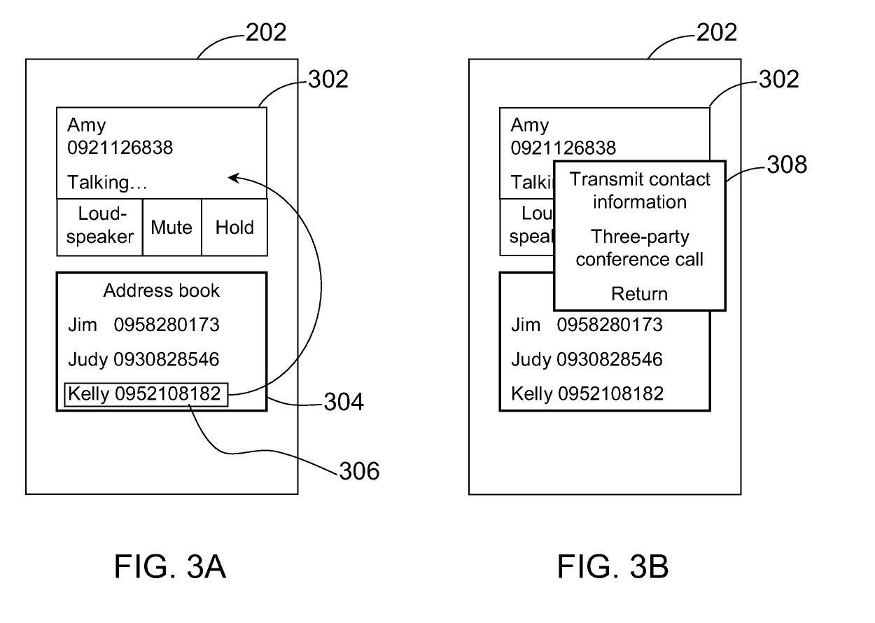

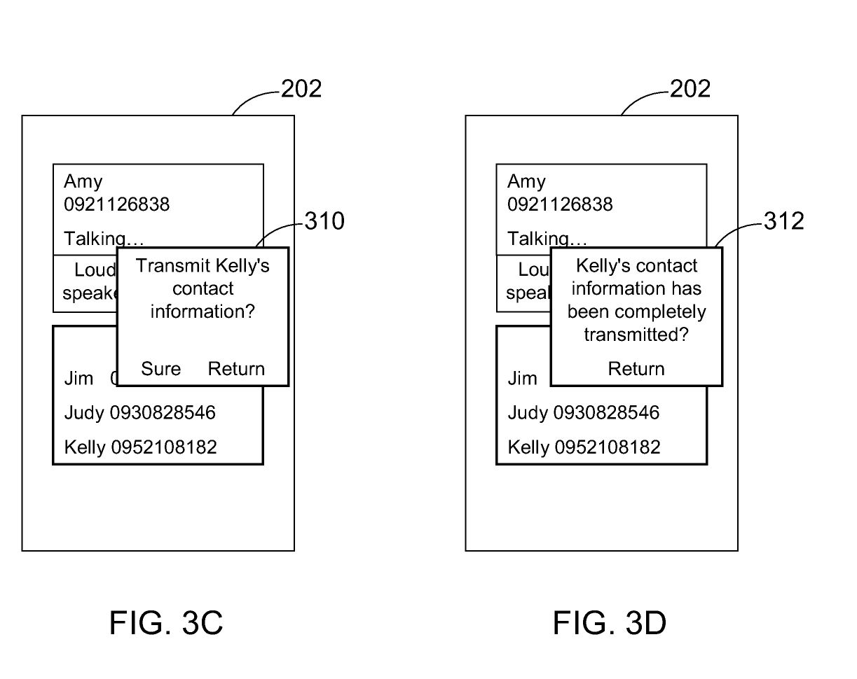

FIGS. 3A to 3D are schematic illustrations showing an example of a screen frame in the communication method of FIG. 1. As shown in a calling window 302 of the screen 202 of FIG. 3A, when the telephone connection between the calling party and the called party (e.g., Amy) is being established, Amy may ask the calling party the third party's (e.g., Kelly's) contact information. At this time, the calling party can open the address book of the communication device to search Kelly's contact information. After the address book is opened, the screen 202 displays a contact list window 304 to show many contact items corresponding to many contacts.

After the calling party has found Kelly's contact item 306, the calling party drags and drops the contact item 306 corresponding to Kelly to the calling window 302. At this time, a selection window 308, in which at least one option/options is/are listed so that the calling party can make a selection, appears on the screen 202. The listed options may contain a “Transmit contact information” option, a “Three-party conference call” option and a “Return” option, as shown in FIG. 3B.

After the calling party selects the “Transmit contact information” option, the screen 202 shows a query window 310 to query whether the calling party surely wants to transmit Kelly's contact information to Amy, as shown in FIG. 3C. If the calling party selects the “Sure” option, the communication device transmits Kelly's contact information in the address book to the called party Amy. After the operation of transmitting is finished, the communication device displays a message window 312 on the screen 202 to inform that the contact information of the calling party Kelly has been completely transmitted.

In the operation of transmitting Kelly's contact information, the communication device can transmit all the contact information corresponding to the contact Kelly to Amy, and may also transmit a portion of the contact information corresponding to the contact Kelly to Amy. For example, the communication device may transmit Kelly's all the contact information, including an address, a home telephone number, an office telephone number, a mobile phone number, a birthday, an email account, and information of a text file or notes associated with Kelly. The communication device may also transmit only a portion of the contact information of Kelly (e.g., only Kelly's telephone number, or one of the information mentioned hereinabove).

In addition, in the operation of transmitting Kelly's contact information, the communication device packages Kelly's contact information as a short message transmitted to Amy in a short message transmit method. The content of the short message may include all the contact information of Kelly, a portion of the contact information of Kelly, or a text file or notes associated with Kelly.

The screen 202 of the communication device 200 is, for example, a touch screen, and is not limited thereto. Thus, the calling party may use a touch pen to finish the drag-and-drop operation and thus generate the calling party event, and the calling party may also directly use one finger to finish the drag-and-drop operation mentioned hereinabove.

Consequently, when the calling party selects the contact Kelly in the address book, the calling party can directly drag and drop Kelly's contact item into the calling window 302 without opening Kelly's contact item, and the communication device 200 can quickly transmit Kelly's contact information to Amy. This operation method can quickly and correctly transmit the contact information so that the calling party can feel the excellent convenience in operation and it is possible to prevent the called party from waiting for the too long time and from feeling fidgety.

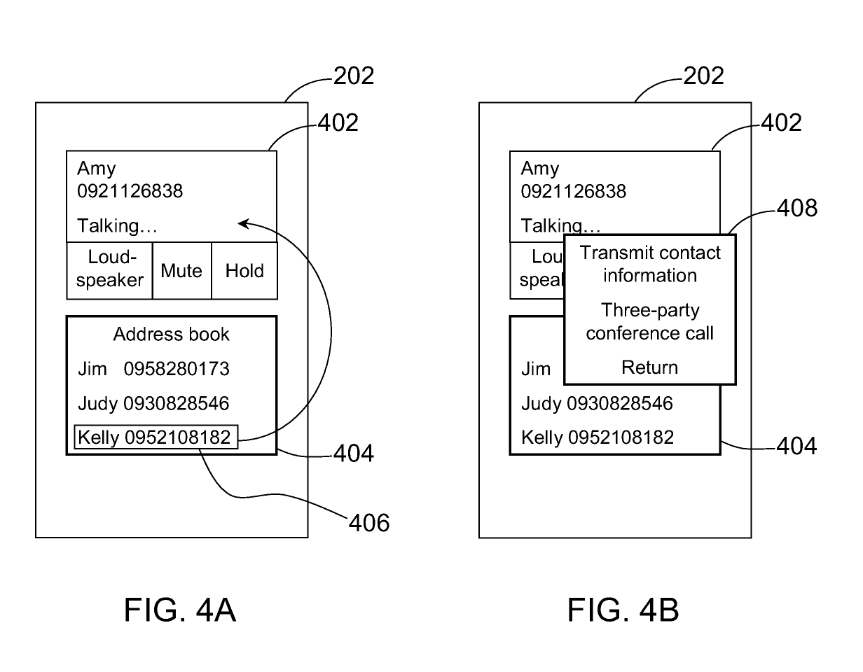

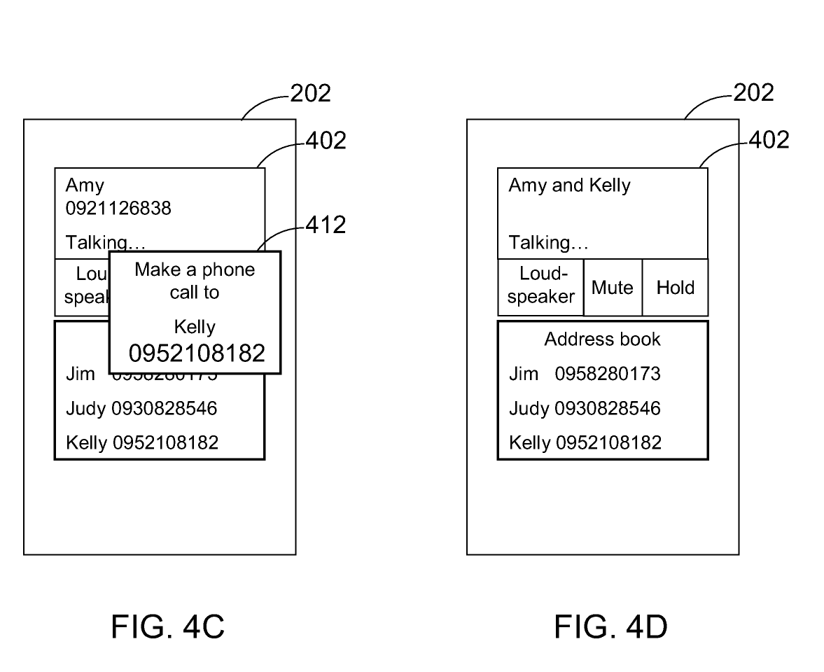

In addition to transmitting the contact information, the drag-and-drop operation may also be used in the mechanism of establishing the multi-party conference call. FIGS. 4A to 4D are schematic illustrations showing another example of the screen frame in the communication method of FIG. 1. As shown in a calling window 402 of the screen 202 of FIG. 4A, when the telephone connection between the calling party and the called party (e.g., Amy) is being established, the calling party may wish to let the third party (e.g., Kelly) participate in the talk. At this time, the calling party can open the address book of the communication device 200 to select the contact to be selected to participate in the talk. After the address book is opened, the screen 202 displays a contact list window 404 to show many contact items corresponding to many contacts.

After the calling party has found Kelly's contact information, the calling party drags and drops a contact item 406 corresponding to Kelly into the calling window 402. At this time, the screen 202 shows a selection window 408, which lists at least one option to be selected by the calling party. The listed options may be, for example, the “Transmit contact information” option, the “Three-party conference call” option and the “Return” option, as shown in FIG. 4B.

After the calling party selects the “Three-party conference call” option, the screen 202 shows a message window 412 to inform the calling party that the communication device is making a phone call to Kelly, as shown in FIG. 4C.

Next, as shown in FIG. 4D, after the multi-party conference call is successfully established, the calling window 402 on the screen 202 of the communication device displays the state of the multi-party conference call with Amy and Kelly.

The step of making the phone call to Kelly preferably includes the following sub-steps. In the first sub-step, the communication device 200 holds the talk of the calling party with Amy. In the second sub-step, the communication device dials the telephone number of Kelly's contact information. In the third sub-step, the talk with Amy is retrieved after the telephone connection with Kelly is established, and the talks between the calling party and Kelly and between the calling party and Amy are combined together to establish a multi-party conference call.

That is, after the calling party selects the “Three-party conference call” option of the selection window 408, the communication device 200 automatically performs the first to third sub-steps, and the calling party can omit the complicated procedure of setting the three-party conference call. Preferably, the communication device 200 performs the first to third sub-steps in the background, and the communication device 200 itself can finish the operation of setting the three-party conference call without the interposition of the calling party.

In addition and preferably, after the calling party selects the “Three-party conference call” option, the screen 202 may first appear another query window (not shown) so that the calling party can make sure whether the multi-party conference call is to be proceeded. After the calling party selects “Sure”, the communication device 200 performs the operation of calling Kelly, and shows the message window 412 after the calling succeeds and the multi-party conference call is established.

The calling party can establish the multi-party conference call instinctively through the drag-and-drop operation according to the simultaneous display of the calling window 402 and the contact list window 404. This method can rapidly add the contact into the calling window 402 so that the multi-party conference call can be established. Compared with the prior art, this method can avoid the condition that the calling party incorrectly presses the option on the frame, or that the calling party unintentionally hangs up the call with the called party because the calling party is unfamiliar with the operation of the multi-party conference call. Thus, the invention has the advantages of the convenient, quick and easy operations.

In addition, although the “Transmit contact information” option, the “Three-party conference call” option and the “Return” option are listed in the selection window 308 of FIG. 3B, the “Three-party conference call” option may also be omitted from the selection window 308. Similarly, although the “Transmit contact information” option, the “Three-party conference call” option and the “Return” option are listed in the selection window 408 of FIG. 4B, the “Transmit contact information” option may also be omitted from the selection window 408.

The communication device may be a mobile phone, a personal digital assistant (PDA) or a portable computer. The electronic device having the screen can be applied to the communication method and the communication device thereof as long as the screen can show two windows so that the calling party can perform the drag-and-drop operation.

The communication method and the communication device thereof according to the invention have the advantages that the operation of the calling party is easy, that the error cannot easily occur, that the communication function between the called party and the associated dragged and dropped contact item can be effectively performed and that the waiting time of each of the calling party and the called party can be shortened so that the product competitiveness is very high.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A communication method, comprising the steps of:
displaying a calling window when a telephone connection between a calling party of a communication device and a called party is established;
displaying a contact list window, which shows at least one contact item corresponding to at least one contact;
dragging and dropping one of the at least one contact item from the contact list window to the calling window; and
performing a communication function relating to the called party and the dragged and dropped contact item.

2. The method according to claim 1, wherein the communication function is a function of transmitting at least a portion of contact information of the dragged and dropped contact item to the called party.

3. The method according to claim 2, wherein the at least a portion of contact information of the dragged and dropped contact item is transmitted to the called party through a short message.

4. The method according to claim 2, wherein the at least a portion of contact information comprises a telephone number corresponding to the contact.

5. The method according to claim 2, wherein the at least a portion of contact information comprises at least one of an address, a home telephone number, an office telephone number, a mobile phone number, a birthday and an email account corresponding to the contact, and information of a text file or notes associated with the contact.

6. The method according to claim 1, wherein the communication function is a function of performing a three-party conference call among the contact of the dragged and dropped contact item, the calling party and the called party.

7. The method according to claim 6, wherein the step of performing the communication function comprises the sub-steps of:
holding a talk with the called party;
dialing a telephone number in contact information of the dragged and dropped contact item; and
retrieving the talk with the called party after a telephone connection with the contact corresponding to the dragged and dropped contact item is established, and combining the talks between the calling party and the contact and between the calling party and the called party together to form a multi-party conference call.

8. The method according to claim 7, wherein the sub-steps of holding the talk with the called party, dialing and forming the multi-party conference call are performed in a background.

9. The method according to claim 1, wherein a screen of the communication device is a touch screen.

10. The method according to claim 1, wherein the communication device is a mobile phone, a personal digital assistant (PDA) or a portable computer.

11. A communication device, comprising:
a screen for displaying a calling window and displaying a contact list window, which shows at least one contact item corresponding to at least one contact, when a telephone connection between a calling party of the communication device and a called party is established;
a control module for controlling the screen and dragging and dropping one of the at least one contact item from the contact list window to the calling window in response to a calling party event; and
a communication module for performing a communication function relating to the called party and the dragged and dropped contact item.

12. The communication device according to claim 11, wherein the communication function is a function of transmitting at least a portion of contact information of the dragged and dropped contact item to the called party.

13. The communication device according to claim 12, wherein the at least a portion of contact information of the dragged and dropped contact item is transmitted to the called party through a short message.

14. The communication device according to claim 12, wherein the at least a portion of contact information comprises a telephone number corresponding to the contact.

15. The communication device according to claim 12, wherein the at least a portion of contact information comprises at least one of an address, a home telephone number, an office telephone number, a mobile phone number, a birthday and an email account corresponding to the contact, and information of a text file or notes associated with the contact.

16. The communication device according to claim 11, wherein the communication function is a function of performing a three-party conference call among the contact of the dragged and dropped contact item, the calling party and the called party.

17. The communication device according to claim 16, wherein the communication module performs the communication function by performing operations of holding a talk with the called party, dialing a telephone number in contact information of the dragged and dropped contact item, retrieving the talk with the called party after a telephone connection with the contact corresponding to the dragged and dropped contact item is established, and combining the talks between the calling party and the contact and between the calling party and the called party together to form a multi-party conference call.

18. The communication device according to claim 17, wherein the communication module performs the operations of holding the talk with the called party, dialing, and forming the multi-party conference call in a background.

19. The communication device according to claim 11, wherein the screen is a touch screen.

20. The communication device according to claim 11, wherein the communication device is a mobile phone, a personal digital assistant, or a portable computer.
